(19) United States
(12) Patent Application Publication
(10) Pub. No.: US 2010/0264281 A1
(43) Pub. Date: Oct. 21, 2010

(54) Gripping Clip and Mounting Apparatus Using Same

(76) Inventors: Joeben Bevirt, Santa Cruz, CA (US); Freditalo Polito, Santa Cruz, CA (US)

Correspondence Address: MICHAEL A. GUTH, 2-2905 EAST CLIFF DRIVE, SANTA CRUZ, CA, 95062, US

(21) Appl. No.: 12/614,400

(22) Filed: Nov. 7, 2009

Related U.S. Application Data
(63) Continuation-in-part of application No. 11/324,994, filed on Jan. 3, 2006.

(51) Int. Cl. F16M 11/04; F16M 13/00

(52) U.S. Cl. 248/121; 248/316.7

(57) ABSTRACT

A clamp clip adapted to grip an item, such as a planar sheet. The clamp clip may have pincers adapted to open and close in a scissors like fashion. The clamp may be used with a tripod or a monopod, and in some embodiments a tripod with flexible legs utilizing ball and socket joint connectors which, when interconnected, form a flexible assembly. The ball and socket joint connectors may utilize an over-molded strip around the outside of the connector to facilitate in their use for gripping when wrapped around objects.

CROSS-REFERENCE TO RELATED APPLICATIONS

This application is a continuation in part of U.S. patent application Ser. No. 11/324,994 to Bevirt, filed Jan. 3, 2006.

### BACKGROUND

1. Field of the Invention

The present invention relates to device mounting, and more specifically to mounting clips that may be used to mount various items to a tripod or other apparatus.

2. Description of Related Art

Mounting devices may come in a variety of forms. Some mounting devices are used to mount various types of hardware to a variety of types of structure. Tripod structures may be used to mount devices.

Typical tripod assemblies consist of three rigid legs which are splayed out to form a support structure for devices such as cameras. The legs are usually rigid and adapted to provide support off of the ground or other flat surface. Some tripods have some adjustment to leg length which may allow for some deviation from flatness in the surface upon which they are mounted. Such tripods are limited in the manner in which they support devices. In addition, new mounting clips are needed to meet the need for mounting a variety of devices.

What is called for is a mounting apparatus that may function as a tripod and also as a grip mount for the mounting to vertical members. What is also called for are accessory clips for mounting of different items to tripods and monopods.

### SUMMARY

The present invention is directed to mounting clips and structures to support the mounting clips. One such clip is a clip adapted to clip onto and hold items such as reflector screens and lighting shades for photography related applications. The clip may be used to hold large screens, and at the same time be adapted to fasten to a tripod or monopod, including tripods which have flexible legs and are adapted to be secured to members such as vertical poles.

The mounting clips may be used with a tripod or a monopod, and in some embodiments a tripod with flexible legs utilizing ball and socket joint connectors which, when interconnected, form a flexible assembly. Each connector includes a body with a first and second end portion. An external socket engaging surface is provided at one end of the body. The other end of the body has an internal cavity. The socket engaging surface of one connector is snapped into the internal cavity of another to interconnect the connectors. In some embodiments, the ball and socket joint connectors utilize an over-molded strip around the outside of the connector to facilitate in their use for gripping.

### BRIEF DESCRIPTION OF THE DRAWINGS

FIG. 1 is a perspective view of a clamp clip according to some embodiments of the present invention.

FIG. 2 is a side view of a clamp clip according to some embodiments of the present invention.

FIG. 3 is a top view of a clamp clip according to some embodiments of the present invention.

FIG. 4 is a front view of a clamp clip according to some embodiments of the present invention.

FIG. 5 is a clamp clip being used of a clamp clip according to some embodiments of the present invention.

FIG. 6 is a view of a tripod and an annular clip with a flashlight according to some embodiments of the present invention.

FIG. 7 is a perspective view of a tripod and a suction clip according to some embodiments of the present invention.

FIG. 8 is a sketch of a unipod with a suction clip according to some embodiments of the present invention.

FIG. 9 is a sketch of a unipod with an electronic device mounted on it according to some embodiments of the present invention.

FIG. 10 illustrates a side view of a plurality of connected connectors according to some embodiments of the present invention.

FIG. 11 illustrates an end view of a plurality of connected connectors according to some embodiments of the present invention.

FIG. 12 is a cross-sectional view of a plurality of connected connectors according to some embodiments of the present invention.

FIG. 13 is a side view of a connector according to some embodiments of the present invention.

FIG. 14 is a cross-sectional view of a connector according to some embodiments of the present invention.

FIG. 15 is illustrates a connector with a gripping portion according to some embodiments of the present invention.

FIGS. 16 and 16A are a side and cross-sectional view of a connector with a gripping portion according to some embodiments of the present invention.

FIG. 17 is an illustration of a tripod apparatus according to some embodiments of the present invention.

FIG. 18 is an illustration of a body and interconnect portion of a tripod apparatus according to some embodiments of the present invention.

FIG. 19 is a cross-sectional view of a body and interconnect portion of a tripod apparatus according to some embodiments of the present invention.

FIG. 20 is an illustration of a tripod apparatus according to some embodiments of the present invention.

FIG. 21 is a side and cross-sectional view of a body and interconnect portion of a tripod apparatus according to some embodiments of the present invention.

FIG. 22 is a side and cross-sectional view of a body and interconnect portion of a tripod apparatus according to some embodiments of the present invention.

FIG. 23 is a side and cross-sectional view of a body and interconnect portion of a tripod apparatus according to some embodiments of the present invention.

FIG. 24 is a top perspective view of a clip according to some embodiments of the present invention.

FIG. 25 is a side view of a clip according to some embodiments of the present invention.

### DETAILED DESCRIPTION

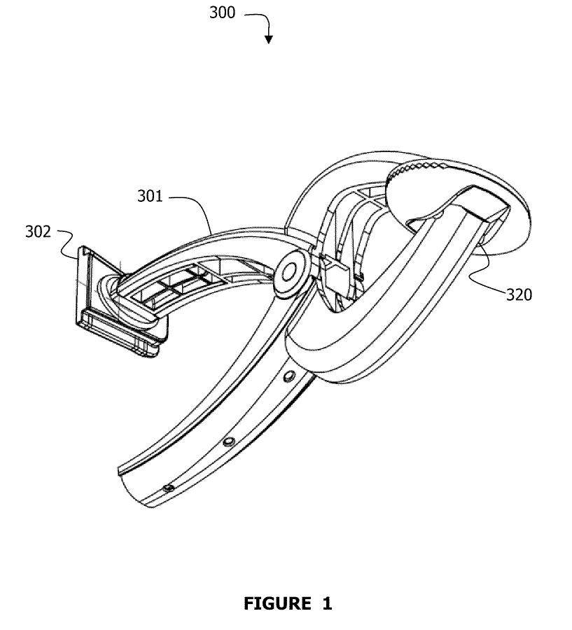

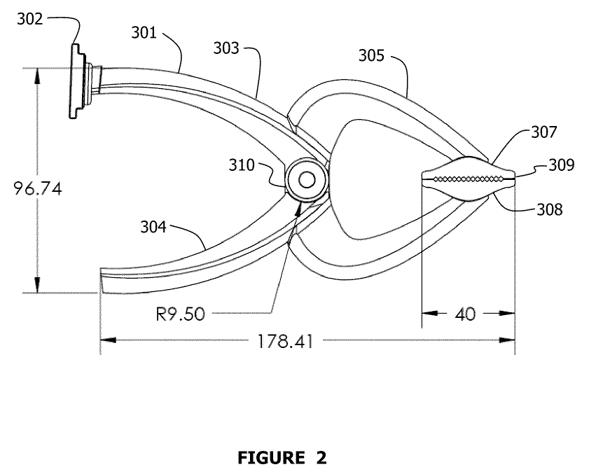

In some embodiments of the present invention, as seen in FIGS. 1-4, a clamp clip 300 has an interface clip 302 and a clamp body 301. In some embodiments, the interface clip 302 is part of a unitary piece with the first arm 303. In some embodiments, the interface clip 302 may be removably attached to the first arm 303 and the clamp body 301. The clamp clip 300 is adapted to clip into a separate support structure such as a tripod or a monopod as described below.

In some embodiments, the clamp body 301 has a first arm 303 and second arm 304 adapted to be squeezed together to open a space between a first pincher 305 and a second pincher 306. The two main pieces of the clamp body 301 may pivot around a main pivot 310. A spring may be used to keep the first pincher and the second pincher in a closed position. In some embodiments, the spring may be a leaf or coil spring which pushes the first arm and the second arm apart.

In some embodiments of the present invention, the first pincher 305 may support a first jaw 307 and the second pincher may support a second jaw 308. The jaws are adapted to grip around a central clamp area 309. In some embodiments, the jaws are pivotally attached to the pinchers to allow for motion and alignment. The jaws may be attached to the pinchers with a pivot pin.

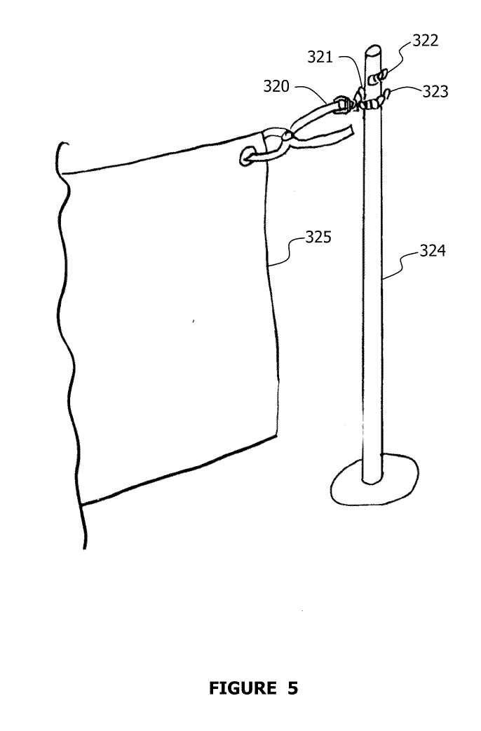

FIG. 5 illustrates a use of the clamp clip according to some embodiments of the present invention. The clamp clip 320 is attached to a flexible gripping tripod 321. Legs 322, 323 of the tripod 321 are seen wrapped around a vertical support 324. The clamp clip 320 is seen supporting a lighting screen 325 for a photographic application. Another clamp clip, or more, may be used to support other portions of the lighting screen. The clamp clip may be used to support a reflective screen, a drape, or other item for photographic purposes. The clamp clip may be used to support similar items, or other items, for a variety of other purposes.

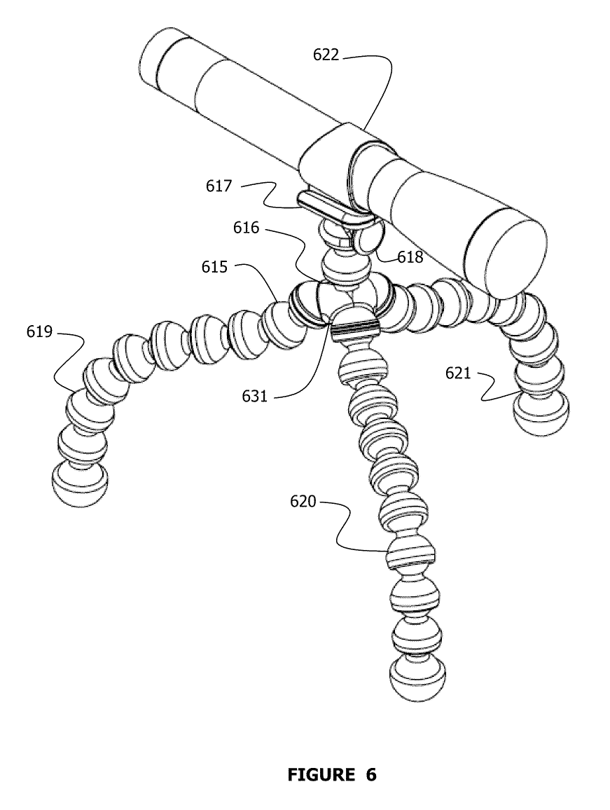

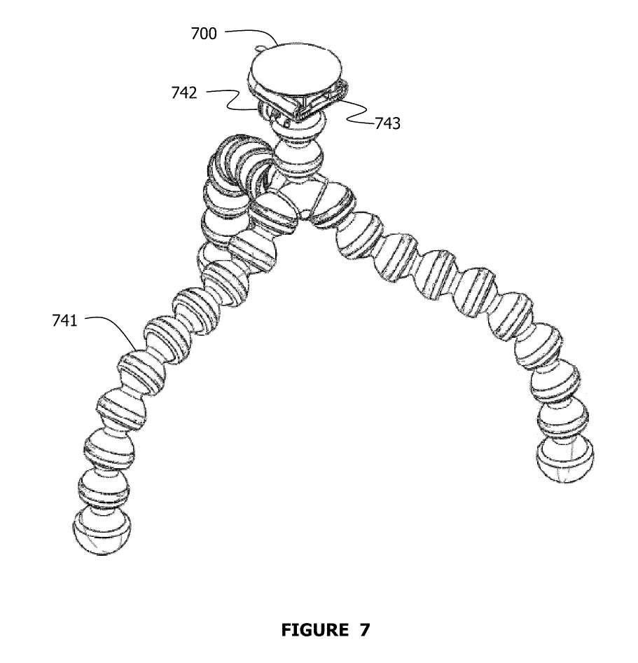

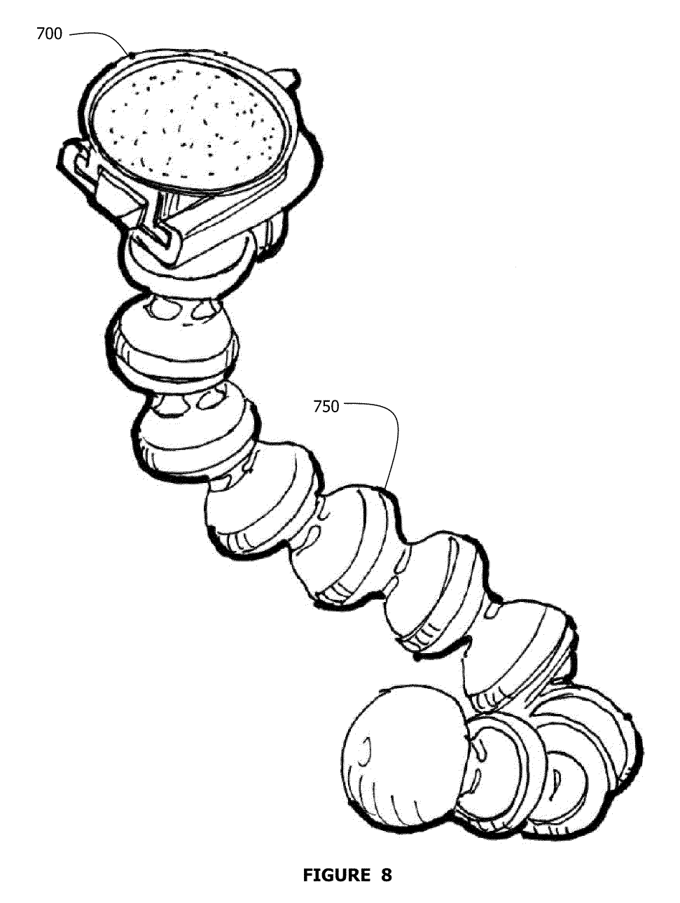

FIG. 6 is a sketch of a tripod and a flashlight inserted into a clip. The flashlight and clip assembly 622 are seen attached to a tripod 631. The flashlight and clip assembly 622 is adapted to be attached into the tripod's interconnect portion 617. A release lever 618 allows for the release of the clip from the interconnect portion of the tripod. The release lever may release a tab that catches within the slot 609 on the bottom of the clip. The main body 616 of the tripod is seen with three flexible legs 619, 620, 621 according to some embodiments of the present invention. The flexible nature of the legs allow the tripod to also be used for gripping to vertical members by wrapping around them. Although illustrated here with a flashlight clip, a similar methodology is used for the clamp clip.

In another clip embodiment, shown to illustrate the nature of the clip and its mating receiver, a clip 700 has a clip base adapted to be clipped into a mating support structure. The clip base may have a flat bottom surface and rails along its sides, or along three sides. The rails allow for the clip to be inserted into a mating interface which is adapted to receive a flat bottomed clip and which has grooves along its sides to receive the rails of the clip. A slot in the bottom surface of the planar bottom of the clip base is adapted to allow for the capture of the clip by a tab when slid into an interfacing portion of a support structure, such as a tripod. A neckdown on the rail allows for easier insertion of the clip into its interfacing connector.

The clip may be used with a support structure as a removably attached clip. The removable aspect of the clip allows the support structure to be used with different types of clips when desired by the user. In addition, the user may want to attach the clip to the device and remove the device with the clip attached from the support structure.

As the case with other clips described herein, the use of a clip that can be fastened to an item, such as a cell phone, flashlight, flash, camera, etc., separate from attachment to the support structure provides greater ease and more versatility for the user.

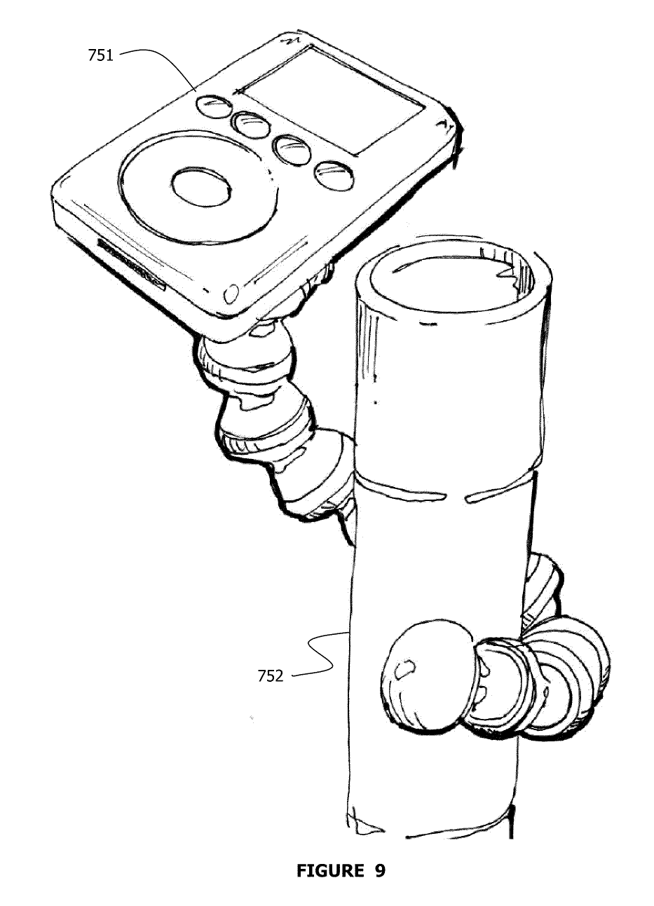

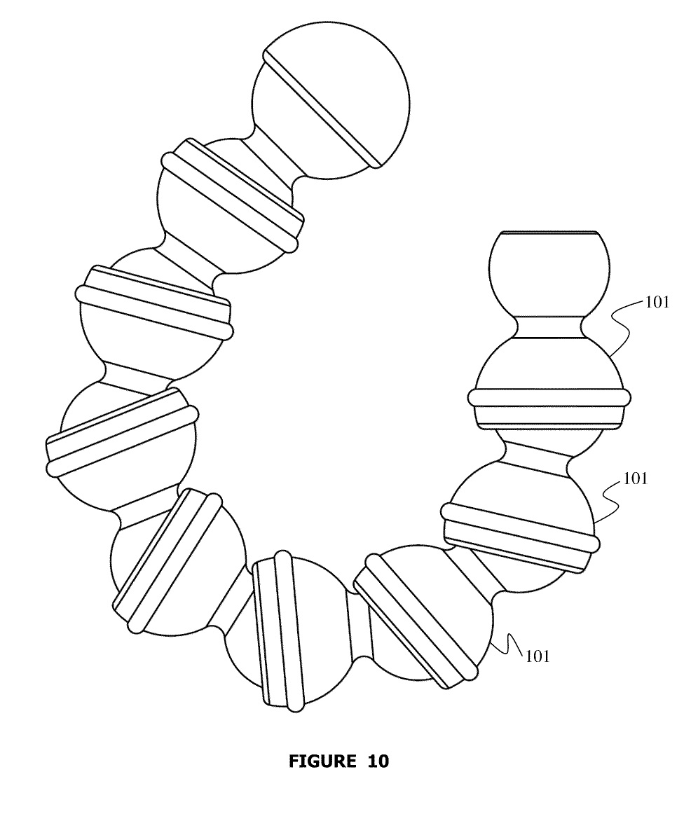

FIGS. 8 and 9 illustrate a monopod, or unipod, with removably attached clips according to some embodiments of the present invention. A monopod 750 is seen with a series of ball and socket connectors with an overmolded grip strip as seen in other embodiments of the present invention. The monopod 750 may have an interface portion which is adapted to receive clips according to embodiments of the present invention. The monopod 750 allows for mounting to members, such as a vertical member 752. An electronic item 751, or other item, may be attached to a mounting clip and supported by the support structure. The clamp clip according to embodiments of the present invention may be used with a monopod as seen herein.

The clamp clip according to some embodiments of the present invention may be used with the clip described above. In some embodiments, the clamp clip may have an internal thread which is adapted to receive a threaded fastener from a separate clip. In some embodiments, the clamp clip may be part of a unitary construction with part of the clamp.

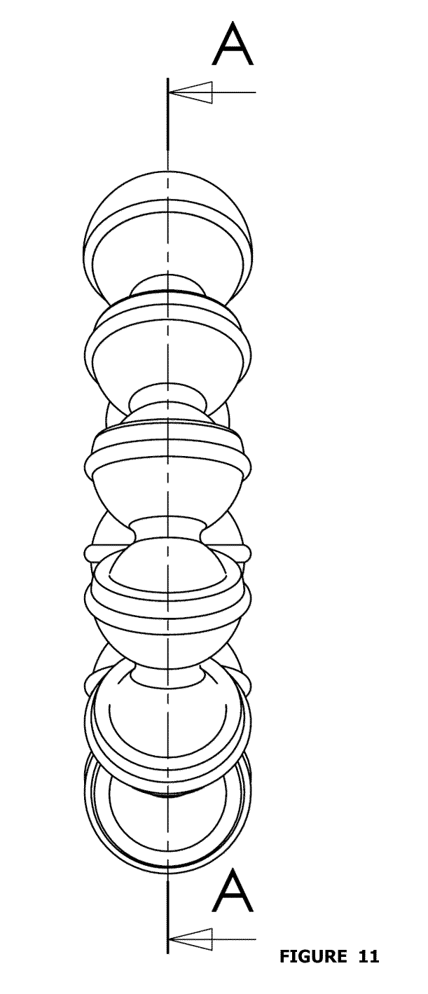

FIGS. 10, 11, and 12 illustrate a plurality of ball and socket joint connectors 101 according to some embodiments of the present invention. A connector 101 has a first end portion 102 and a second end portion 103. A socket engaging end surface 104 is present at the first end 102. The first end portion 102 is substantially hollowed out.

The second end portion 103 has a body 106 with an internal socket receiving cavity 107. The inner surface 110 of the an internal socket receiving cavity 107 is adapted to fit over the socket engaging end surface 104 of another connector 101, or of another piece with a similar socket engaging end surface. A neckdown 105 separates the first end portion 102 from the second end portion 103. A stop nub 108 acts as a mechanical stop to prevent over angulation and possible unintentional separation of a ball and socket joint connector pair.

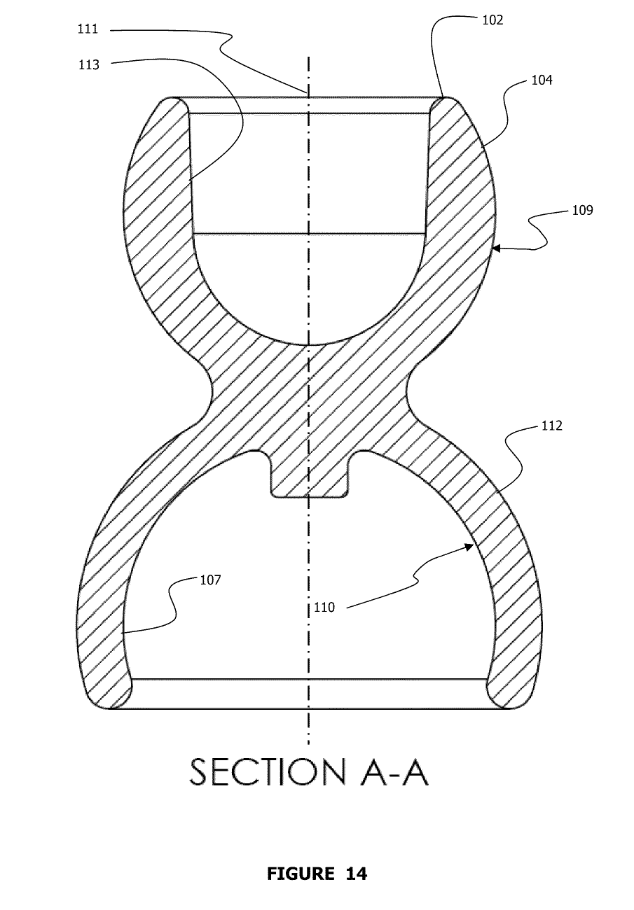

As seen in FIG. 13, the connector 101 has a primary axis 111 in some embodiments. The connector 101 may be symmetric around the primary axis 111 in some embodiments. The end surface planes of the first and second end portions of the connector may be perpendicular to the primary axis 111 in some embodiments.

In some embodiments of the present invention, the wall thicknesses of the internal socket receiving cavity or the socket engaging end surface, or both, are constructed so that an interference fit remains after the ball and socket joint connectors are connected. In some embodiments, the interference fit is designed such that the material is stressed to a stress level below that of the plastic limit but above the creep limit. The material may then creep until the interference is at or below the creep limit, typically down to the upper end of the elastic deformation stress range of the material. In such an embodiment using a plurality of connectors connected together to form a longer chain, the stresses will tend to equalize in the different connector pairs. This equalization of stresses will tend to equalize the frictions of the various connector pairs. An equalization of the frictions in the connector pairs in a long chain of connected connectors will tend to allow the chain of connectors to bend in a smooth fashion when the chain is subjected to bending forces. For example, in a 10 unit chain bent to a 45 degree angle, the bending may be well spread among the connector pairs.

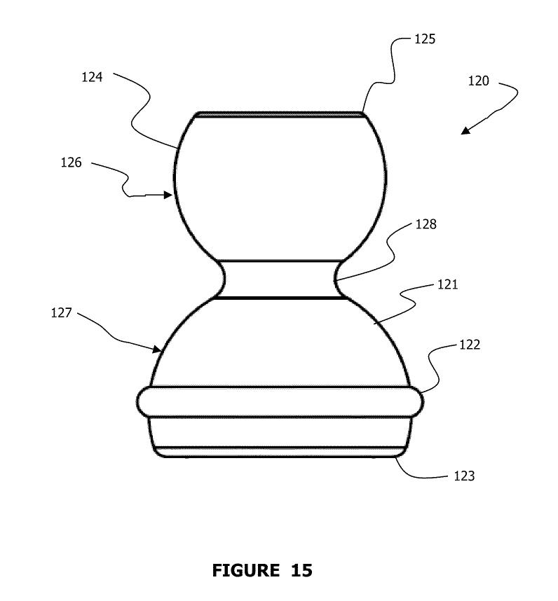

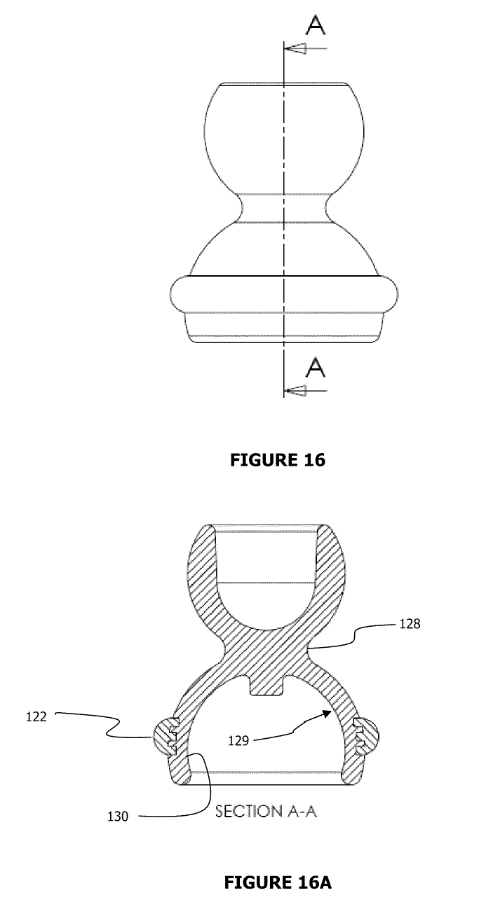

In some embodiments, as seen in FIGS. 15, 16 and 16A, a connector 120 includes a gripping portion 122. The connector 120 has a first end portion 125 and a second end portion 123. A socket engaging end surface 124 is present at the first end 125. The first end portion 125 is substantially hollowed out.

The second end 123 has a body 121 with an internal socket receiving cavity 130. The inner surface 129 of the an internal socket receiving cavity 130 is adapted to fit over the socket engaging end surface 124 of another connector, or of another piece with a similar socket engaging end surface. A neckdown 128 separates the first end portion 125 from the second end portion 123. A gripping portion 122 allows the connector to grip surfaces more readily. In some embodiments, the gripping portion is co-molded into the connector body. In some embodiments, the gripping portion is a rubberized compound. In some embodiments, the gripping portion is a circumferential ring molded into the outer surface of the connector. The gripping portion may provide a higher friction interface when the connector is set upon or wrapped around an object.

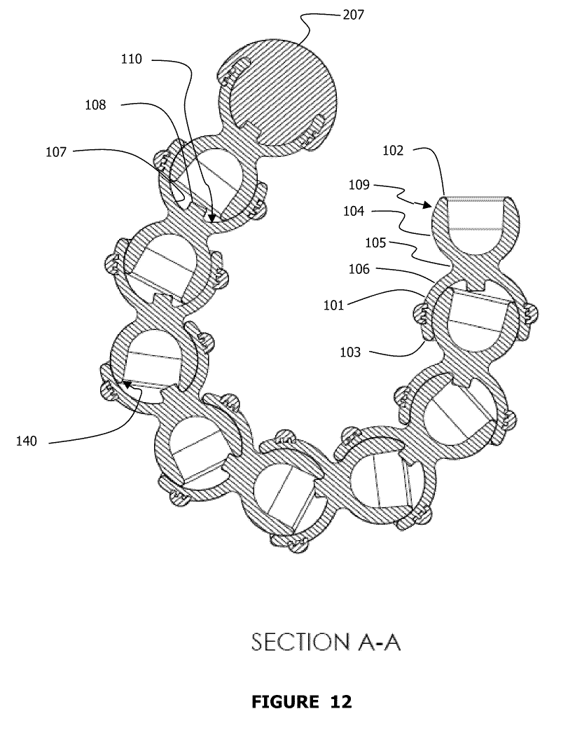

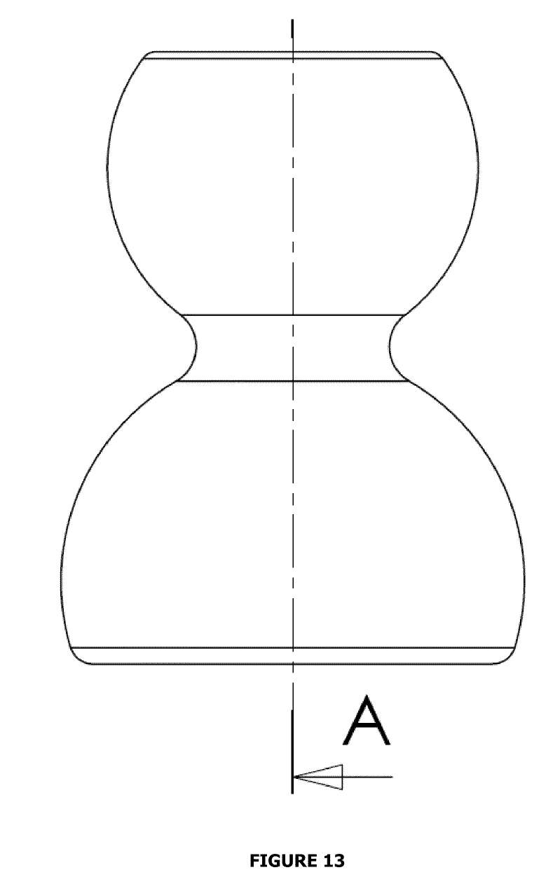

FIG. 12 illustrates a cross-sectional view of a plurality of ball and socket joint connectors. In some embodiments of the present invention, a stop nub 108 resides within the internal socket receiving cavity. The inner rim 140 of the socket engaging end surface 104 is adapted to contact the stop nub 108 as the two connectors reach a certain angle relative to each other. The contact of the stop nub 108 and the inner rim 140 of the socket engaging end surface 104 acts as a mechanical stop with regard to further angulation of the two pieces relative to each other. The mechanical stop function works to prevent over-rotation and possible disconnection of the two connectors.

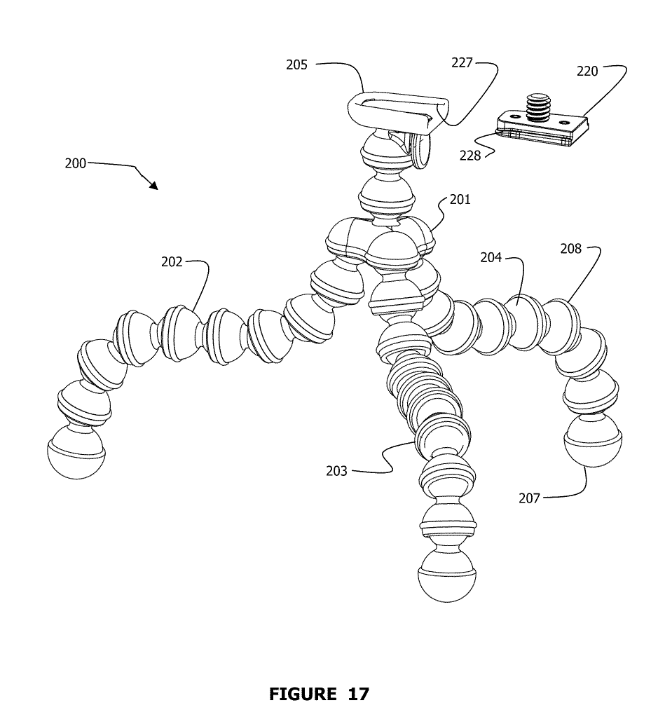

FIG. 17 illustrates a tripod apparatus 200 according to some embodiments of the present invention. A body portion 201 provides a base of support for three flexible legs 202, 203, 204. The flexible legs 202, 203, 204 consist of a series of interconnected ball and socket joint connectors. The flexible legs are able to be flexed into a variety of positions and can be used to support the body portion 201 by forming tripod support. The flexible legs are able to adapt to uneven surfaces to allow the tripod to function in a variety of situations. Although three legs are used here for illustration, more legs may be present in some embodiments. As seen, the body portion 201 itself may have a series of interconnected ball and socket joint connectors within it, allowing for even more flexibility with regard to its mounting function.

Although the flexible legs are illustrated as functioning legs, the legs are of sufficient flexibility that the may be used to wrap around items such as bars or other objects in order to fasten the tripod apparatus to objects that would not be suitable for mounting of a typical tripod. In conjunction with the gripping portion, this allows the tripod apparatus to be fastened to a variety of objects. For example, when used to position a digital camera, the legs may wrap around a vertical gate rail, allowing the mounting of the camera for a photo taking opportunity not previously available.

In some embodiments, the body portion 201 is connected to an interconnect portion 205. A clip 220 is removably fastened to the interconnect portion 205. The clip 220 may have a threaded post adapted to fit into a camera or other device in some embodiments.

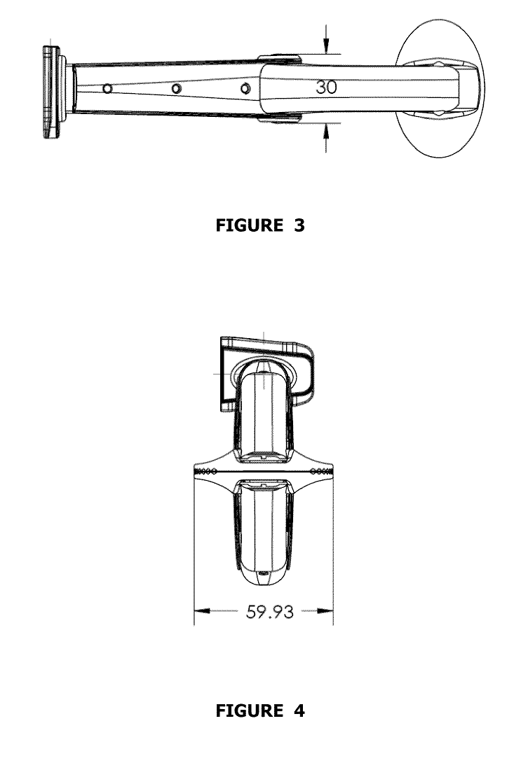

In some embodiments, the flexible legs 202, 203, 204 may use connectors that have a co-molded gripping portion 208. The gripping portions 208 may allow for use of the tripod in a variety of ways, including wrapping of the legs around a post or other object. In some embodiments, the flexible legs may be terminated with a gripping pod 207. As seen in cross-section in FIG. 3, the gripping pod 207 may be fully molded into the cavity of the connector. In some embodiments, the terminal connector of each leg has a socket engaging end surface on its first end and a suction cup on its second end. The suctions cups may allow for a secure attachment of the tripod apparatus 200 to a variety of surfaces.

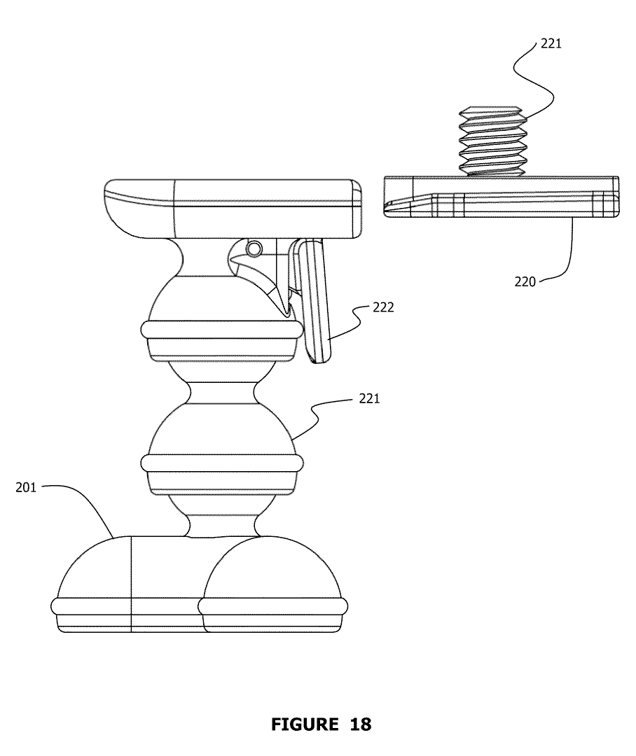

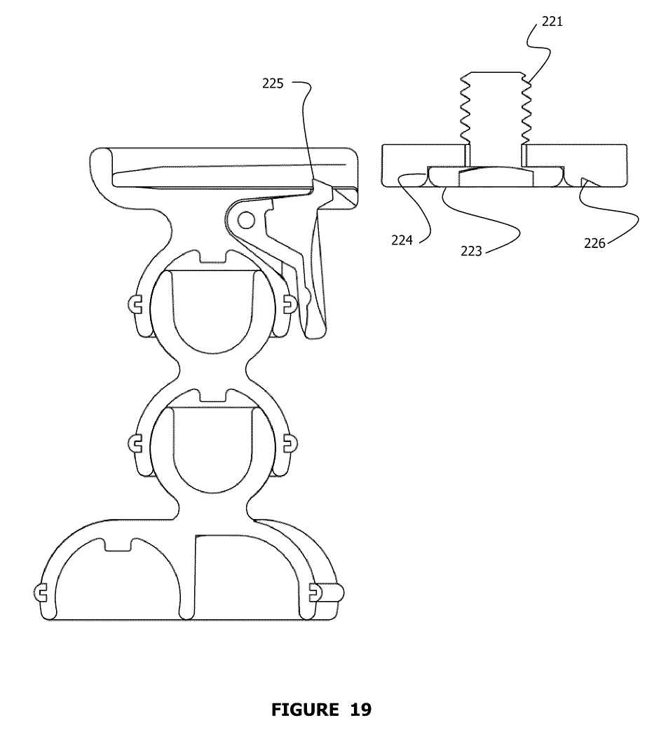

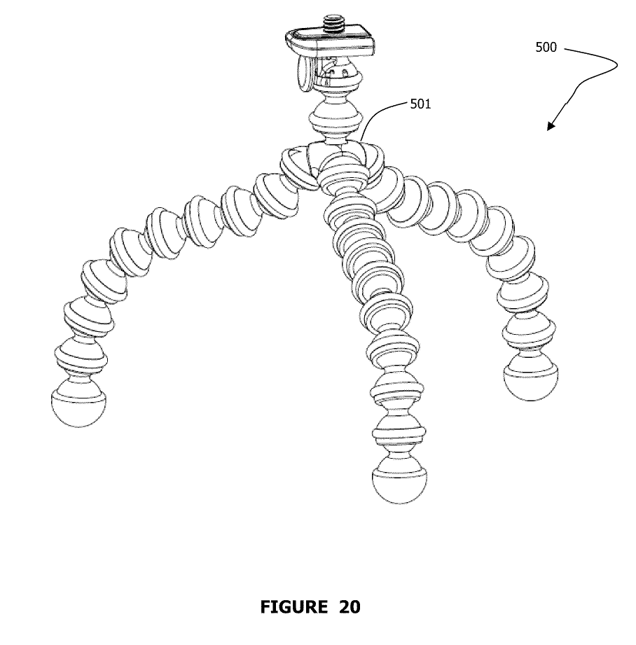

In some embodiments of the present invention, as further illustrated in FIGS. 18 and 19, the interconnect portion 205 is adapted to receive a clip 220. The clip 220 may have rails 228 adapted to slide into slots 227 within the interconnect portion 205. The clip 220 may have recess 226 adapted to be filled by a tab 225 on a spring loaded lever 222. The clip is removably attached to the interconnect portion 205 and may be released by pressing on the lever 222. In some embodiments, the lever 222 is on the same side of the interconnect portion 205 as which the clip 220 slides in on. In other embodiments, the lever 222 is on the side opposite that which the clip 220 slides in on.

A mounting screw 221 may be recess mounted into the clip 220 in some embodiments. The screw 223 may be of the standard size and thread to attach to a camera in some embodiments. The head 223 of the screw 221 may be held into the recess 224 by a slight ridge in the molding of the recess in some embodiments.

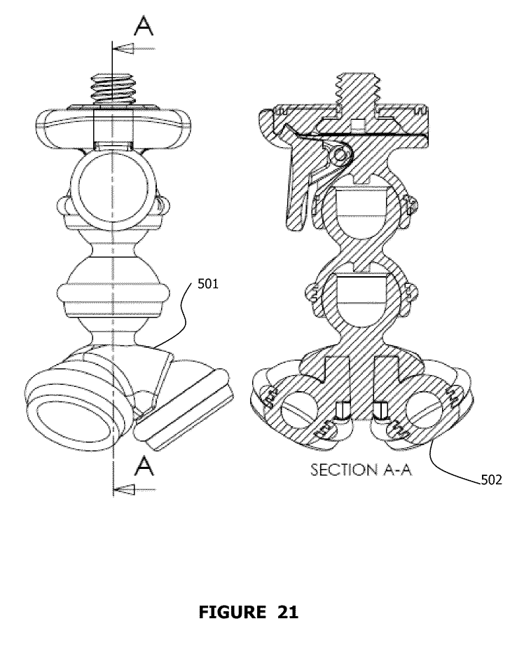

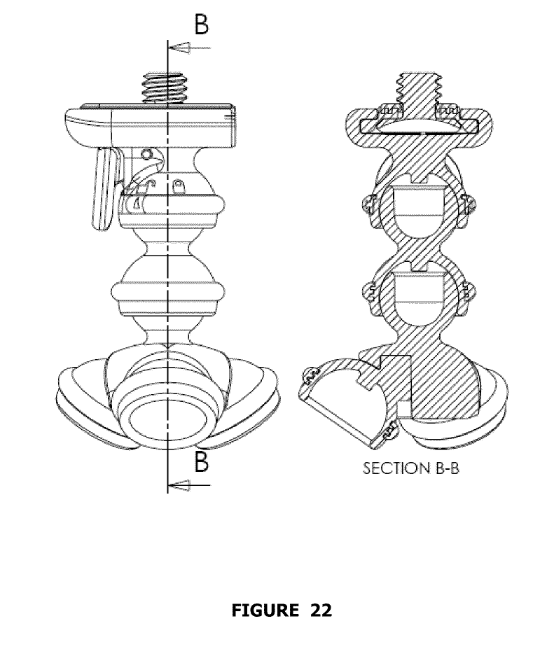

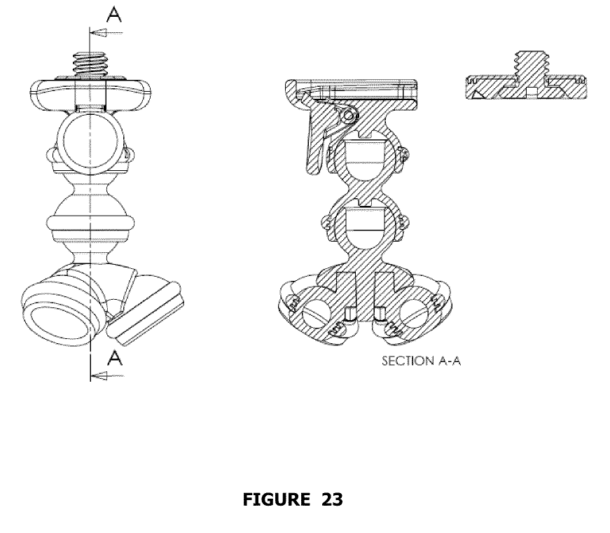

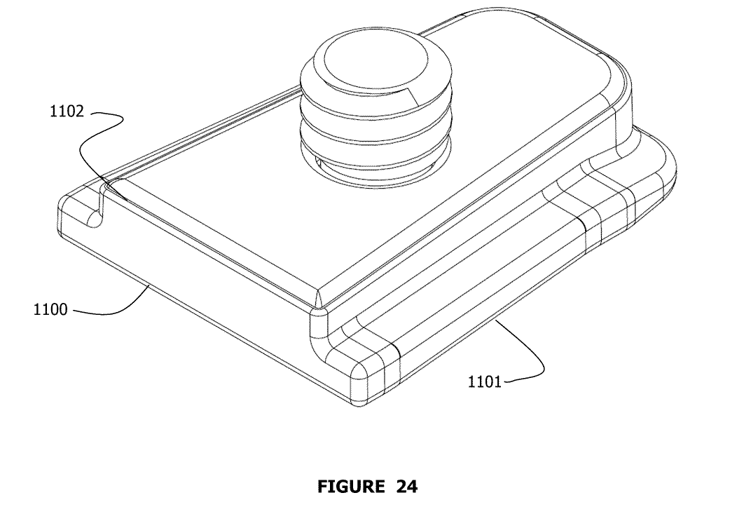

In some embodiments of the present invention, as seen in FIGS. 20, 21, 22, and 23, a tripod apparatus 500 utilizes a body portion 501 which spaces and locates the legs of the apparatus in a different configuration. The spacing of the body sockets 502 allows for better use of the tripod legs as attaching arms in some uses. In some embodiments, the body sockets 502 are equally spaced around the center of the body portion 501. The body sockets are also flared at an angle relative to the ground (in typical usage). In some embodiments, the flared angle is 45 degrees. The flaring of the body sockets allows a different range of potential wrapping angles for the legs of the tripod.

With the flaring of the body sockets, the tripod legs may still be utilized as in the case of a typical tripod. The range of motion of the body sockets and the connectors which form the legs still allow for vertical positioning of the legs. Thus, the body portion 501 retains the tripod's usual functionality. The flaring, however, allows for greater bending of the legs in cases where the legs are used as gripping arms, such as when wrapped around vertical bars and the like. Thus the body portion 501 adds to the range of positions and to the types of uses that the apparatus may entertain.

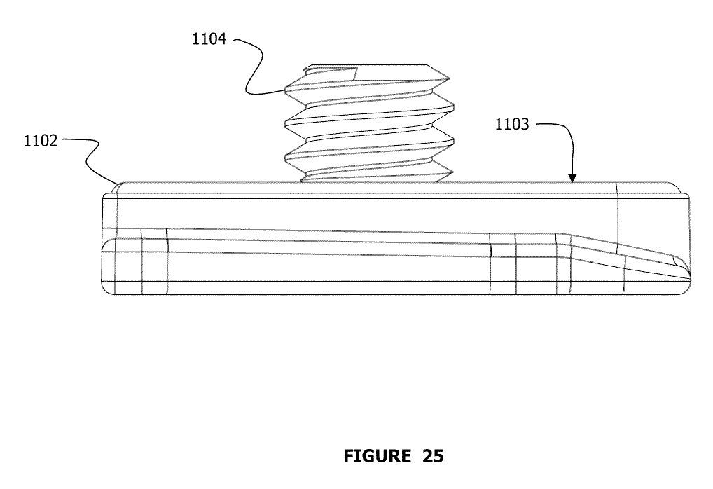

FIGS. 24 and 25 illustrate a clip according to some embodiments of the present invention. A clip 1100 is shown with a main body 1101 and a grip surface 1102. The clip 1100 is adapted to attach to a support structure such as a tripod. The clip 1100 may have a substantially flat bottom surface with a recess therein. The recess may be adapted to be filled by a tab which is adapted to be filled by a tab on a spring loaded lever.

When the clip is attached to an electronic device such as a camera, or into a clamp, the threaded portion 1104 is threaded up into the device or clamp. This is done when the clip is not attached to the support structure, and allows for the clip to be attached to camera, or other device, just once, and from then on the clip may be clipped to the support structure without requiring repetitive threading into the device. The clip is small enough that it may be stored with the camera.

In some cases, there may be concern that the attached item may rotate relative to the clip 1100 even after tightening of the threads up in to the item. A grip surface 1102 allows for a grabbier surface 1103 to be in contact with the device or camera. The grip surface 1102 may be overmolded onto the main body 1101 in some embodiments. The grip surface 1102 may compress somewhat when the camera is threaded on to the clip. The grip surface may greatly reduce the likelihood of rotary movement of the camera relative to the clip.

As evident from the above description, a wide variety of embodiments may be configured from the description given herein and additional advantages and modifications will readily occur to those skilled in the art. The invention in its broader aspects is, therefore, not limited to the specific details and illustrative examples shown and described. Accordingly, departures from such details may be made without departing from the spirit or scope of the applicant's general invention.

I claim:

1. A clamp clip comprising:
a clamp body, said clamp body comprising:
a first arm;
a second arm, said second arm pivotally attached to said first arm; and
an interface clip, said interface clip attached to said first arm, said interface clip adapted to be clipped into a mating clip receiver.

2. The clamp clip of claim 1 further comprising:
a first pincher attached to said first arm; and
a second pincher attached to said second arm.

3. The clamp clip of claim 2 further comprising a spring, said spring adapted to hold said first pincher against said second pincher.

4. The clamp clip of claim 3 further comprising:
a first jaw attached to said first pincher; and
a second jaw attached to said second pincher.

5. The clamp clip of claim 4 wherein said first jaw is pivotally attached to said first pincher, and wherein said second jaw is pivotally attached to said second pincher.

6. The clamp clip of claim 4 wherein said interface clip is removably attached to said first arm.

7. An apparatus comprising
a body portion;
a plurality of flexible legs, said flexible legs comprising a first end and a second end, said first end connected to said body portion;
an interconnect portion connected to said body portion;
a clip receiver; and
a removably attached clamp clip , said clamp clip comprising:
a clamp body, said clamp body comprising:
a first arm;
a second arm, said second arm pivotally attached to said first arm; and
an interface clip, said interface clip attached to said first arm, said interface clip adapted to be clipped into said clip receiver.

8. The apparatus of claim 7 wherein each of said plurality of flexible legs comprises a plurality of connectors, said connectors comprising:
a connector body, said connector body comprising:
a first end portion;
a second end portion; and
a longitudinal axis extending from said first end portion to said second end portion;
a socket engaging end surface at said first end portion, said socket engaging end surface being the external surface at said first end portion; and
an internal socket receiving cavity at said second end portion.

9. The apparatus of claim 8 wherein said connector body further comprises a gripping portion, said gripping portion co-molded to said connector.

10. The apparatus of claim 9 wherein said gripping portion comprises a rubberized compound.

11. The apparatus of claim 10 wherein said gripping portion comprises a circumferential ring co-molded into the outer surface of said second end portion of said connector body.

12. The apparatus of claim 7 wherein said clamp clip further comprises:
a first pincher attached to said first arm; and
a second pincher attached to said second arm.

13. The apparatus of claim 12 wherein said clamp clip further comprises:
a first jaw attached to said first pincher; and
a second jaw attached to said second pincher.

14. The apparatus of claim 13 wherein said first jaw is pivotally attached to said first pincher, and wherein said second jaw is pivotally attached to said second pincher.

15. The apparatus of claim 13 wherein said interface clip is removably attached to said first arm.

16. The apparatus of claim 11 wherein said clamp clip further comprises:
a first pincher attached to said first arm; and
a second pincher attached to said second arm.

17. The clip of claim 16 further comprising:
a first jaw attached to said first pincher; and
a second jaw attached to said second pincher.

18. The apparatus of claim 17 wherein said first jaw is pivotally attached to said first pincher, and wherein said second jaw is pivotally attached to said second pincher.

19. The apparatus of claim 17 wherein said interface clip is removably attached to said first arm.
